(19) United States
(12) Patent Application Publication
(10) Pub. No.: US 2024/0139626 A1
(43) Pub. Date: May 2, 2024

(54) GAME INTERACTION METHOD AND APPARATUS, DEVICE AND MEDIUM

(71) Applicant: Douyin Vision Co., Ltd., Beijing (CN)

(72) Inventor: Xiaoying MA, Beijing (CN)

(21) Appl. No.: 18/466,316

(22) Filed: Sep. 13, 2023

(30) Foreign Application Priority Data
Oct. 27, 2022 (CN) 202211327838.2

(51) Int. Cl. A63F 13/52; A63F 13/426; A63F 13/54

(52) U.S. Cl. CPC A63F 13/52; A63F 13/426; A63F 13/54; A63F 13/44

(57) ABSTRACT

The present disclosure relates to a game interaction method and apparatus, a device and a medium. The method displays a game screen corresponding to a target game and plays a game audio corresponding to the target game, receives a trigger operation of a user based on a target operation identification corresponding to the game audio; and if the trigger operation is a valid operation corresponding to the target operation identification, displays a target scene element at a target position of the main game scene, the target position being a preset display position of the target scene element on the main game scene.

### CROSS-REFERENCE TO RELATED APPLICATIONS

The present disclosure is based on and claims priority to China Patent Application No. 202211327838.2 filed on Oct. 27, 2022 and entitled as “GAME INTERACTION METHOD AND APPARATUS, DEVICE AND MEDIUM”, the disclosure of which is incorporated by reference herein in its entirety.

### TECHNICAL FIELD

The present disclosure relates to the technical field of games, and in particular, to a game interaction method and apparatus, a device, and a medium.

### BACKGROUND

With the continuous development of internet technologies, various video games applied to electronic devices are becoming more abundant to increase entertainment life of users. And in order to make players have better game experience, game scenes are usually set to be in a dynamic change form, so as to make the players appear to be on the same scene.

### SUMMARY

The present disclosure provides a game interaction method and apparatus, a device and a medium.

In a first aspect, the present disclosure provides a game interaction method, comprising:
displaying a game screen corresponding to a target game and playing a game audio corresponding to the target game, the game screen comprising a main game scene;
receiving a trigger operation of a user based on a target operation identification corresponding to the game audio; and
if the trigger operation is a valid operation corresponding to the target operation identification, displaying a target scene element at a target position of the main game scene, the target position being a preset display position of the target scene element on the main game scene.

In a second aspect, the present disclosure provides a game interaction apparatus comprising:
a screen displaying unit configured to display a game screen corresponding to a target game and play a game audio corresponding to the target game, the game screen comprising a main game scene;
an operation receiving unit configured to receive a trigger operation of a user based on a target operation identification corresponding to the game audio; and
a first displaying unit configured to, if the trigger operation is a valid operation corresponding to the target operation identification, display a target scene element at a target position of the main game scene, the target position being a preset display position of the target scene element on the main game scene.

In a third aspect, the present disclosure provides an electronic device, comprising:
a processor;
a memory configured to store executable instructions;
wherein the processor is configured to read the executable instructions from the memory and execute the executable instructions to implement the game interaction method of the first aspect.

In a fourth aspect, the present disclosure provides a non-transitory computer-readable storage medium storing a computer program which, when executed by a processor, causes the processor to implement the game interaction method of the first aspect.

### BRIEF DESCRIPTION OF THE DRAWINGS

The above and other features, advantages, and aspects of the embodiments of the present disclosure will become more apparent by referring to the following DETAILED DESCRIPTION when taken in conjunction with the accompanying drawings. Throughout the drawings, the same or similar reference numbers refer to the same or similar elements. It should be understood that the drawings are schematic and that elements and components are not necessarily drawn to scale.

FIG. 1 is a schematic flowchart of a game interaction method provided by embodiments of the present disclosure;

FIG. 2a is a schematic diagram of a game interaction interface provided by embodiments of the present disclosure;

FIG. 2b is a schematic diagram of another game interaction interface provided by embodiments of the present disclosure;

FIG. 3 is a schematic flowchart of another game interaction method provided by embodiments of the present disclosure;

FIG. 4 is a schematic flowchart of further another game interaction method provided by embodiments of the present disclosure;

FIG. 5 is a schematic flowchart of yet another game interaction method provided by embodiments of the present disclosure;

FIG. 6 is a schematic flowchart of yet another game interaction method provided by embodiments of the present disclosure;

FIG. 7 is a schematic flowchart of yet another game interaction method provided by embodiments of the present disclosure;

FIG. 8 is a schematic flowchart of yet another game interaction method provided by embodiments of the present disclosure;

FIG. 9 is a schematic structural diagram of a game interaction apparatus provided by embodiments of the present disclosure;

FIG. 10 is a schematic structural diagram of an electronic device provided by embodiments of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather these embodiments are provided for a more complete and thorough understanding of the present disclosure. It should be understood that the drawings and the embodiments of the present disclosure are for illustration purposes only and are not intended to limit the scope of the present disclosure.

It should be understood that the various steps recited in method embodiments of the present disclosure may be performed in a different order, and/or performed in parallel. Moreover, the method embodiments may include additional steps and/or omit performing the illustrated steps. The scope of the present disclosure is not limited in this respect.

The term “comprising” and variations thereof as used herein are intended to be open-ended, i.e., “comprising but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the terms “first”, “second”, and the like in the present disclosure are only used for distinguishing different devices, modules or units, and are not used for limiting the order or interdependence of the functions performed by the devices, modules or units.

It is noted that references to “a” or “an” in this disclosure are intended to be illustrative rather than limiting, and that those skilled in the art should appreciate that they should be understood as “one or more” unless the context clearly indicates otherwise.

The names of messages or information exchanged between devices in the embodiments of the present disclosure are for illustrative purposes only, and are not intended to limit the scope of the messages or information.

At present, with the continuous development of internet technologies, various video games applied to electronic devices are becoming more abundant to increase entertainment life of users. And in order to make players have better game experience, game scenes are usually set to be in a dynamic change form, so as to make the players appear to be on the same scene. However, it is generally only supported in rhythm games, to change actions of an operation object by the operation of the player, and the player cannot interact with the game scene itself, so that the game experience of the player is reduced.

In view of the defects of the related art in the aspect of game interaction, the present disclosure provides an game interaction method and apparatus, device and medium, which can display a game screen corresponding to a target game and play a game audio corresponding to the target game, the game screen comprising a main game scene; receive a trigger operation of a user based on a target operation identification corresponding to the game audio; and if the trigger operation is a valid operation corresponding to the target operation identification, display a target scene element at a target position of the main game scene, the target position being a preset display position of the target scene element on the main game scene, so that the first game screen is richer, screen content of the first game screen is more and more perfect, the user can interact with the game scene itself, and the game experience of the user is improved.

The game interaction method provided by the embodiment of the present disclosure may be executed by an electronic device, in which a game interaction apparatus may be integrated, the apparatus may be implemented by software and/or hardware; the electronic device may be understood as any device with processing capability and computing capability, and the device may include, but is not limited to, a mobile terminal such as a smart phone, a notebook computer, a Personal Digital Assistant (PDA), a tablet computer (PAD), a Portable Multimedia Player (PMP), a vehicle-mounted terminal (e.g., a vehicle-mounted navigation terminal), a wearable device, and a fixed electronic device such as a digital TV, a desktop computer, a smart home device.

Compared with the related art, the technical solution provided by the embodiments of the present disclosure has the following advantages:

The game interaction method and apparatus, device and medium according to the embodiments of the present disclosure can display a game screen corresponding to a target game and play a game audio corresponding to the target game, the game screen comprising a main game scene; receive a trigger operation of a user based on a target operation identification corresponding to the game audio; and if the trigger operation is a valid operation corresponding to the target operation identification, display a target scene element at a target position of the main game scene, the target position being a preset display position of the target scene element on the main game scene, so that the game screen is richer, screen content of the game screen is more and more perfect, the user can interact with the game scene itself, and the game experience of the user is improved.

In order to better understand the inventive concept of the embodiments of the present disclosure, the technical solutions of the embodiments of the present disclosure will be described below with reference to exemplary embodiments.

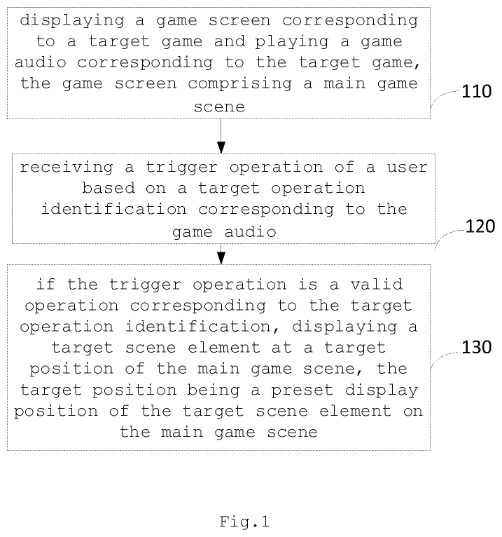

FIG. 1 is a flowchart of a game interaction method provided by an embodiment of the present disclosure, and as shown in FIG. 1, the game interaction method provided by the embodiment includes steps 110-130:

Step 110, displaying a game screen corresponding to a target game, and playing a game audio corresponding to the target game, the game screen comprising a main game scene.

The target game in the embodiment of the present disclosure may be a rhythm game in which rhythms are matched with actions (keyboard, controller, body action, etc.), such as a music game.

The game screen in the embodiment of the present disclosure may be understood as a screen displayed on an interactive interface of an electronic device during the running of a game, and may also be understood as a screen of a game operation performed by a user, and may include a plurality of game scenes, for example, scenes of topics such as city scenes, country scenes, life scenes.

The main game scene in the embodiment of the present disclosure may be understood as a main game scene set for the target game.

The game audio in the embodiment of the present disclosure may be understood as an audio of a preset duration composed of a plurality of beat points, related to the target game, for example, an audio related to a game scene.

The game audio and the game screen in the embodiment of the present disclosure may be set by default in the electronic device, or may be selected by the user as needed, which is not specifically limited herein.

In the embodiment of the present disclosure, the electronic device can start to operate in response to a target game of the user, and run the target game, wherein a scene loader in the electronic device can load a game screen, then the game screen corresponding to the target game can be displayed on an interactive interface of the electronic device; the game screen comprises a main game scene, and an audio player in the electronic device can load and play a game audio corresponding to the target game. The start operation may be an operation such as click, long-press, double-click of a game start icon, or may be a game start operation performed by voice control, expression control, or the like, and the embodiment of the present disclosure is not particularly limited.

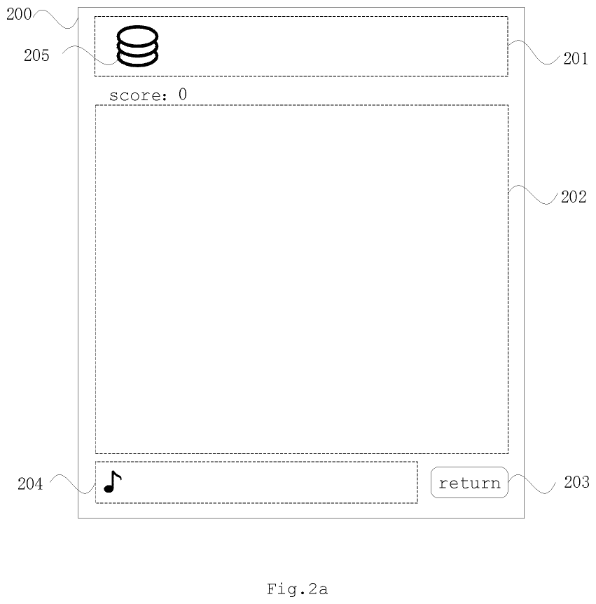

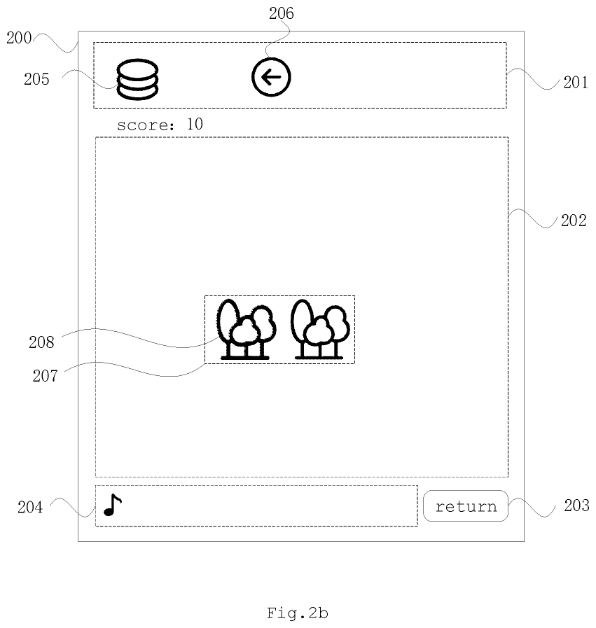

For example, FIG. 2a provides a schematic diagram of a game interactive interface; as shown in FIG. 2a, 200 is an interactive interface of an electronic device, 201 is a display area of a target operation identification corresponding to a game audio, 202 is a display area of a game screen corresponding to a target game, 203 is a return to previous button, 204 is a content display area of the game audio, 205 is a game score identification; during the running of the target game, the game screen 202 corresponding to the target game displayed on the interactive interface is a blank screen, and the game audio 204 corresponding to the target game is played.

Step 120, receiving a trigger operation of a user based on a target operation identification corresponding to the game audio.

The target operation identification in the embodiment of the present disclosure may be understood as a touch button associated with a beat of the game audio and having a trigger operation instruction identification, for example, a button with a different display color, a button with a different direction, a button with a different touch duration, beating a certain specified animal identification button, and the like, wherein the button with a different display color may be applied in a scene similar to a piano key, for example, black represents a black key, and white represents a white key; the button with a different direction may be a button for left, right, up, down, and the like; the button with a different touch duration may be a button for making a response more than a preset touch duration, and the like; other buttons such as a score button may be also included in the interactive interface, which is not limited specifically here. The operation object may include an operation instruction, for example, the operation instruction of a button pointed to the left may be to swipe the button to the left. A beat can be understood as a unit that measures the rhythm of the audio.

The trigger operation of the target operation identification in the embodiment of the present disclosure may be a click operation, a press operation, a swipe operation, and the like of the user with respect to the target operation identification on the interactive interface, or may also be a click operation, a press operation, a swipe operation, and the like of the user in a designated touch area corresponding to the target operation identification appearing in the interactive interface, which is not specifically limited herein.

In the embodiment of the present disclosure, after the electronic device displays a game screen corresponding to a target game and plays a game audio corresponding to the target game, a beat generator in the electronic device may perform a dotting insertion operation according to the game audio, to generate a set of beat points corresponding to the game audio; a game manager in the electronic device may detect the set of beat points corresponding to the game audio in advance, then generate a target operation identification corresponding to each beat point according to the set of beat points, and control a moving area, a moving speed, and a moving direction of the target operation identification corresponding to each beat point according to a time interval of the beat points; a user may perform a trigger operation on the target operation identification corresponding to the game audio on the interactive interface, and then the electronic device may receive a trigger operation of the user based on the target operation identification corresponding to the game audio.

Step 130, if the trigger operation is a valid operation corresponding to the target operation identification, displaying a target scene element at a target position of the main game scene, the target position being a preset display position of the target scene element on the main game scene.

In the embodiment of the present disclosure, the valid operation corresponding to the target operation identification may be understood as that the user steps on the target operation identification of the game audio corresponding to the target game through the trigger operation on the target operation identification, and may include any one or any combination of: a trigger operation input by the user being the same as the operation instruction in the target operation identification, the user performing a trigger operation in a designated touch area corresponding to the target operation identification appearing in the interactive interface, a time difference between the time when the user performs the trigger operation and the time when the target operation identification starts being within a preset time period, and may also include other manners, which are not specifically limited herein.

The target scene element in the embodiment of the present disclosure may be understood as an element for enriching a target game screen, for example, the target scene element may include a scene element corresponding to the case that a total user score after the end of the current trigger operation reaches a certain threshold, for example, a scene element corresponding to praise, celebration, encouragement, and the like, when the total user operation score reaches a certain threshold, and may further include a preset scene element corresponding to a target beat point to which a target operation identification targeted by the current operation belongs, where the preset scene elements may include buildings, plants, animals, and the like.

The target position in the embodiment of the present disclosure may be understood as a preset display position of the target scene element on the main game scene, where the preset display position may be set according to actual needs, and is not specifically limited herein.

In the embodiment of the present disclosure, after receiving a trigger operation of a user based on a target operation identification corresponding to a game audio, the electronic device may first determine, by using a trigger, whether the trigger operation is a valid operation corresponding to the target operation identification.

In some embodiments, determining whether the trigger operation is a valid operation corresponding to the target operation identification may be made by determining whether the trigger operation input by the user is the same as the operation instruction of the target operation identification; if the trigger operation input by the user is the same as the operation instruction of the target operation identification, it is determined that the trigger operation is an valid operation, and if the trigger operation input by the user is different from the operation instruction of the target operation identification, it is determined that the trigger operation is an invalid operation, for example, if the target operation identification A is a button pointing to the left, the operation instruction of the target operation identification A is swipe left, and if the user swipes the target operation identification A to the left, the trigger operation is the valid operation.

In other embodiments, determining whether the trigger operation is a valid operation corresponding to the target operation identification may be made by determining whether the touch area of the trigger operation of the user is within the designated touch area corresponding to the target operation identification; if the touch area of the trigger operation of the user is within the designated touch area corresponding to the target operation identification, it is determined that the trigger operation is a valid operation corresponding to the target operation identification, and if the touch area of the trigger operation of the user is not within the designated touch area corresponding to the target operation identification, it is determined that the trigger operation is not a valid operation corresponding to the target operation identification.

In some embodiments, determining whether the trigger operation is a valid operation corresponding to the target operation identification may be made by determining whether a time difference between the time when the user performs the trigger operation and the time when the target operation identification starts is within a preset time period; if the time difference between the time when the user performs the trigger operation and the time when the target operation identification starts is within the preset time period, it is determined that the trigger operation is a valid operation corresponding to the target operation identification, and if the time difference between the time when the user performs the trigger operation and the time when the target operation identification starts is not within the preset time period, it is determined that the trigger operation is not a valid operation corresponding to the target operation identification.

In still other embodiments, determining whether the trigger operation is a valid operation corresponding to the target operation identification may be made by comprehensively determining whether the touch area of the trigger operation of the user is within the designated touch area corresponding to the target operation identification and whether the trigger operation input by the user is the same as the operation instruction of the target operation identification, and the trigger operation is determined as a valid operation only if the touch area of the trigger operation of the user is within the designated touch area corresponding to the target operation identification and the trigger operation input by the user is the same as the operation instruction of the target operation identification.

After determining that the trigger operation is a valid operation corresponding to the target operation identification, the electronic device may control a decoration manager to display the target scene element at the target position of the main game scene.

For example, FIG. 2b provides a schematic diagram of a game interaction interface, and as shown in FIG. 2b, 206 is a certain target operation identification 206 of a game audio, and the target operation identification 206 is a button pointing to the left, then an operation instruction of the target operation identification 206 is swipe left; if the trigger operation of the user is to swipe the target operation identification 206 to the left, it is determined that the trigger operation is a valid operation, then a target scene element 208 is displayed at a target position 207 of the main game scene; the target scene element 208 is a tree, the target scene element 208 enriches the game screen 202, and a score corresponding to the game score identification 205 is increased by 10 points, which indicates that the score of the current trigger operation is 10 points.

According to the embodiment of the present disclosure, in the running process of the target game, the target game screen corresponding to the target game is displayed, and the game audio corresponding to the target game is played; the target game screen comprises a first main game scene, the beat operation input by the user based on a first beat point of the game audio corresponding to the target game is received, and under the condition that the beat operation is a valid operation corresponding to the first beat point, a first scene element corresponding to the first beat point is displayed at the target position of the first main game scene, so that the target game screen is richer, and further, the screen content of the target game screen is more and more perfect, the user can interact with the game scene itself, and the game experience of the user is improved.

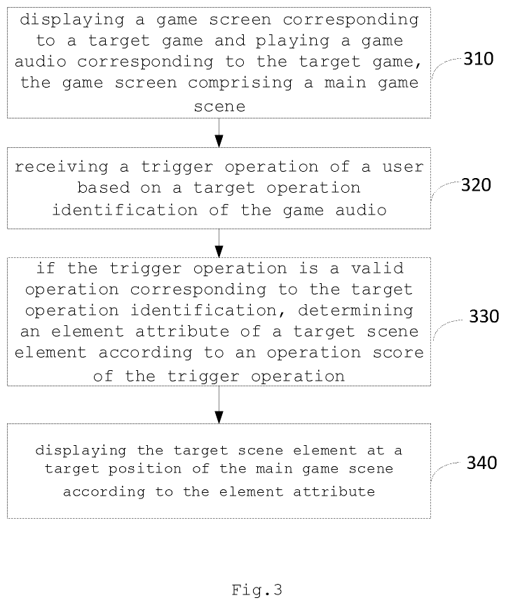

FIG. 3 is a flowchart of a game interaction method provided in an embodiment of the present disclosure, and as shown in FIG. 3, the game interaction method provided in the embodiment includes steps 310-340:

Step 310, displaying a game screen corresponding to a target game and playing a game audio corresponding to the target game, the game screen comprising a main game scene.

Step 320, receiving a trigger operation of a user based on a target operation identification of the game audio.

The steps 310-320 in the embodiment of the present disclosure can refer to the contents of the steps 110-120, which are not described herein again.

Step 330, if the trigger operation is a valid operation corresponding to the target operation identification, determining an element attribute of a target scene element according to an operation score of the trigger operation.

In the embodiment of the present disclosure, after determining that the trigger operation is a valid operation corresponding to the target operation identification, the electronic device may score the trigger operation, and determine an operation score of the trigger operation, for example, the electronic device may score the trigger operation according to an accuracy degree of the trigger operation, for example, the smaller time difference between the time when the user performs the trigger operation and the time when the target operation identification starts, the more accurate the trigger operation, and the higher operation score of the trigger operation.

The element attribute in the embodiment of the present disclosure may include color richness, shape perfection, etc. of the element.

In the embodiment of the present disclosure, after determining the operation score of the trigger operation, the electronic device may determine the element attribute of the target scene element according to the operation score of the trigger operation. The higher the operation score of the trigger operation, the higher the element attribute of the target scene element, for example, the richer the color of the element, the more perfect the shape; the lower the operation score of the trigger operation, the lower the element attribute of the target scene element, e.g., the more monotonous the color of the element, the more missing the shape.

Step 340, displaying the target scene element at a target position of the main game scene according to the element attribute.

In the embodiment of the present disclosure, after determining the element attribute of the target scene element, the electronic device may display the target scene element at the target position of the main game scene according to the element attribute. For example, as the element attribute is higher, the more colorful and the more perfect in shape of the target scene element displayed at the target position of the main game scene.

According to the embodiment of the present application, by displaying a game screen corresponding to a target game and playing a game audio corresponding to the target game, the game screen comprising a main game scene; then receiving a trigger operation of a user based on a target operation identification corresponding to the game audio; if the trigger operation is a valid operation corresponding to the target operation identification, determining an element attribute of a target scene element according to an operation score of the trigger operation; and displaying the target scene element at a target position of the main game scene according to the element attribute, the game screen is richer, the screen content of the game screen is more and more perfect, the user can interact with the game scene itself, and the game experience of the user is improved.

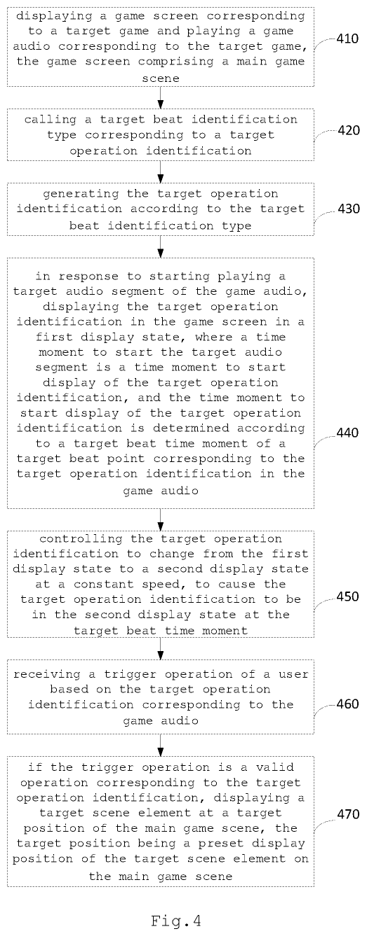

FIG. 4 is a flowchart of a game interaction method provided in an embodiment of the present disclosure, and as shown in FIG. 4, the game interaction method provided in the embodiment includes steps 410-470:

step 410, displaying a game screen corresponding to a target game, and playing a game audio corresponding to the target game, the game screen comprising a main game scene.

For the content in the embodiment of the present disclosure, reference may be made to the content in the step 110 described above, and details are not described here.

Step 420, calling a target beat identification type corresponding to a target operation identification.

In the embodiment of the present disclosure, each target operation identification corresponds to one target beat point of the game audio, the target beat identification type may be understood as a numerical value type corresponding to the target beat point, the numerical value type may include a boolean value (Bool) type and an integer value (Int) type, the boolean value type may include a True value (True) type and a False value (False) type, the integer value type may include integer value types of 0, 1, 2, 3, and the like, and each target beat point may correspond to a different target beat identification type.

In the embodiment of the present disclosure, the target beat identification type corresponding to the target operation identification may be set in advance according to actual needs, and may be stored in a local storage space, and may also be stored in a remote server, which is not specifically limited herein.

In the embodiment of the present disclosure, after the electronic device obtains the target beat point corresponding to the target operation identification, the game manager in the electronic device may call the target beat identification type corresponding to the target beat point from the local storage space or the remote server, according to the target beat point.

Step 430, generating the target operation identification according to the target beat identification type.

In the embodiment of the present disclosure, after calling the target beat identification type corresponding to the target operation identification, the electronic device may generate the target operation identification according to the target beat identification type.

For example, when the target beat identification type is a true value type of the boolean value type, the target operation identification corresponding to the target beat identification type may be a button with a display color of black or a button pointing to the left; when the target beat identification type is a false value type of the boolean value type, the target operation identification corresponding to the target beat identification type may be a button with a display color of white or a button pointing to the right; when the target beat identification type is a 0 value type of the integer value type, the target operation identification corresponding to the target beat identification type may be a button pointing upward or a button for beating animal identification 0; when the target beat identification type is a 1 value type of the integer value type, the target operation identification corresponding to the target beat identification type may be a button pointing downward or a button for beating animal identification 1; when the target beat identification type is a 2 value type of the integer value type, the target operation identification corresponding to the target beat identification type may be a button with a preset touch duration or a button for beating animal identification 2.

Step 440, in response to starting playing a target audio segment of the game audio, displaying the target operation identification in the game screen in a first display state, where a time moment to start the target audio segment is a time moment to start display of the target operation identification, and the time moment to start display of the target operation identification is determined according to a target beat time moment of a target beat point corresponding to the target operation identification in the game audio.

In the embodiment of the present disclosure, the first display state may include displaying at a first position in a target operation identification display area within the electronic device interaction interface, may also include displaying at a first display brightness within the target operation identification display area, and may also include displaying at the first display brightness at the first position in the target operation identification display area, which is not limited specifically here.

In the embodiment of the present disclosure, the game audio may include a plurality of target audio segments, where a target audio segment may be understood as audio of a certain time period, and the electronic device may display the target operation identification within a time period when the target audio segment is played.

In the embodiment of the present disclosure, the time moment to start the target audio segment may be understood as the time moment to start display of the target operation identification, each target operation identification corresponds to one target beat point, each target beat point corresponds to one target beat time moment in the game audio, and the time moment to start display of the target operation identification may be determined according to the target beat time moment of the target beat point corresponding to the target operation identification in the game audio.

In the embodiment of the present disclosure, in the process of displaying the game screen corresponding to the target game and playing the game audio corresponding to the target game, the electronic device may, in response to starting playing the target audio segment of the game audio, display the target operation identification in the game screen in the first display state.

Step 450, controlling the target operation identification to change from the first display state to a second display state at a constant speed, to cause the target operation identification to be in the second display state at the target beat time moment.

The second display state in the embodiment of the present disclosure is a state in which the target operation identification is in at the target beat time moment.

In some embodiments, the second display state may be displaying at a second position in the target operation identification display area, a beat termination mark is disposed at the second position, the beat termination mark may represent an end mark of the target operation identification corresponding to the target beat point, the target operation identification will end its display after the target beat time is displayed at the beat termination mark, and the user may perform a trigger operation on the target operation identification at the second position. In some embodiments, existing elements in the game screen can be taken as the beat termination marks, so that the existing elements in the game screen can be used as the beat termination marks, a special beat termination control is not required to be provided to end the display of the target operation identification, the space and field of view of content presentation can be improved, and the user experience is improved. For example, as shown in FIG. 2b, if the second position is the game score indication 205, i.e. the game score indication 205 is set as the beat termination mark, the electronic device may control 206 to move from the first position in the figure to the second position corresponding to the game score indication 205 at a constant speed.

In other embodiments, the second display state may be displaying in the target operation identification display area at a second display brightness, which is different from the first display brightness, for example, the second display brightness is greater than the first display brightness.

In still other embodiments, the second display state may be displaying at a second location in the target operation identification display area at a second display brightness.

In the embodiment of the present disclosure, after the electronic device displays the target operation identification in the first display state, the electronic device may control the target operation identification to change from the first display state to the second display state at a constant speed, to cause the target operation identification to be in the second display state at the target beat time moment.

Step 460, receiving a trigger operation of a user based on the target operation identification corresponding to the game audio.

Step 470, if the trigger operation is a valid operation corresponding to the target operation identification, displaying a target scene element at a target position of the main game scene, the target position being a preset display position of the target scene element on the main game scene.

The steps 460-470 in the embodiment of the present disclosure can refer to the contents of the steps 120-130, which are not described herein again.

For example, as shown in FIG. 2b, if the second position is the game score identification 205, that is, the game score identification 205 is set as a beat termination mark, after the electronic device controls the target operation identification 206 to move from the first position in the figure to the second position corresponding to 205 at a constant speed, a trigger operation of the user on the target operation identification 206 is received; if the trigger operation is a valid operation corresponding to the target operation identification 206, a target scene element 208 is displayed at a target position 207 of the main game scene, and if the trigger operation is not a valid operation corresponding to the target operation identification 206, no response is made.

Therefore, the user can more accurately trigger the target operation identification at the target beat time moment in the game process, the game control of the user is facilitated, the game screen is richer, the screen content of the game screen is more and more perfect, so that the user can interact with the game scene itself, and the game experience of the user is improved.

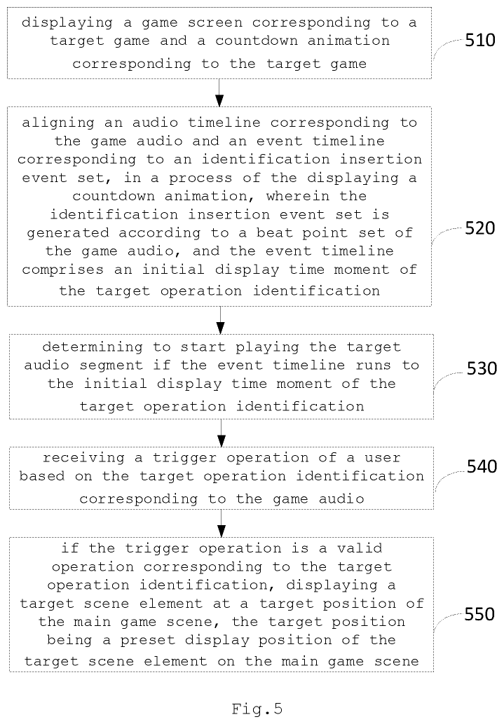

FIG. 5 is a flowchart of a game interaction method provided in an embodiment of the present disclosure, and as shown in FIG. 5, the game interaction method provided in the embodiment includes steps 510 and 550:

Step 510, displaying a game screen corresponding to a target game and displaying a countdown animation corresponding to the target game.

In the embodiment of the present disclosure, because in the electronic device, the playing of the game audio and the generation of the target operation identification are performed independently, there may be a time difference between the playing of the game audio and the target operation identification corresponding to the game audio, therefore, the electronic device may display the countdown animation corresponding to the target game at any position on the interactive interface, according to an amount of time provided before the playing of the game audio, while displaying the game screen corresponding to the target game.

The countdown in the embodiment of the present disclosure may be understood as a countdown before the game audio starts to be played, and the countdown animation may be understood as an animation image frame corresponding to each time moment displayed during the countdown.

Step 520, in a process of displaying the countdown animation, aligning an audio timeline corresponding to the game audio and an event timeline corresponding to an identification object insertion event set, wherein the identification object insertion event set is generated according to a beat point set of the game audio, and the event timeline comprises an initial display time moment of the target operation identification.

The audio timeline in the embodiment of the present disclosure may be understood as a set of various time moments from the start to the end of the playing of the game audio.

The identification object insertion event set in the embodiment of the present disclosure may be understood as an event set of inserting the target operation identification at each target beat point in the game audio, and may be generated according to the beat point set of the game audio, where each target operation identification corresponds to a target beat point in the beat point set.

The event timeline in the embodiment of the present disclosure may be understood as a set of respective time moments at which the target operation identification is inserted at respective target beat points in the game audio. The event timeline comprises a starting display time moment of the target operation identification. The identification object insertion events in each identification object insertion event set are in one-to-one correspondence with the time in the event timeline.

In the embodiment of the present disclosure, in the display process of the countdown animation of the electronic device, a timer in the electronic device may align the audio timeline corresponding to the game audio and the event timeline corresponding to the identification object insertion event set, according to the amount of time provided before playing the game audio, so that the game audio and the target operation identification corresponding to the game audio may be played simultaneously.

Step 530, if the event timeline runs to an initial display time moment of the target operation identification, determining to start playing the target audio segment.

In the embodiment of the present disclosure, after aligning the audio timeline corresponding to the game audio and the event timeline corresponding to the identification object insertion event set, if the event timeline runs to the initial display time moment of the target operation identification, that is, the time moment is the initial display time moment of the target operation identification in the interactive interface, the electronic device may start to play the target audio segment at the initial display time moment according to the audio timeline corresponding to the game audio, and at this time, the target audio segment and the target operation identification corresponding to the target audio segment may be played simultaneously.

Step 540, receiving a trigger operation of a user based on the target operation identification corresponding to the game audio.

Step 550, if the trigger operation is a valid operation corresponding to the target operation identification, displaying a target scene element at a target position of the main game scene, the target position being a preset display position of the target scene element on the main game scene.

The steps 540-550 in the embodiment of the present disclosure may refer to the contents of the steps 120-130, and are not described herein again.

Therefore, the game audio and the target operation identification corresponding to the game audio can be played synchronously, so that the game screen is richer, the screen content of the game screen is more and more perfect, the user can interact with the game scene itself, and the game experience of the user is improved.

In other embodiments of the present disclosure, when the running of the target game ends, the electronic device may further obtain a user operation total score, and if the user operation total score is greater than or equal to a score threshold corresponding to the target game, may display preset multimedia content. The score threshold in the embodiment of the present disclosure may be set as needed, and is not limited specifically here.

The user operation total score in the embodiment of the present disclosure may be understood as a sum of scores of all the trigger operations performed by the user in the whole process of the target game.

The preset multimedia content in the embodiment of the present disclosure may be understood as some wonderful content related to the game scene displayed in the target game process, and may include, but is not limited to, video, image, text, and the like.

Therefore, corresponding rewards can be given to the game operations of the user and the user is encouraged to continuously improve their game operation skills, such that the user can more interact with the game scene itself, and the game experience of the user is improved.

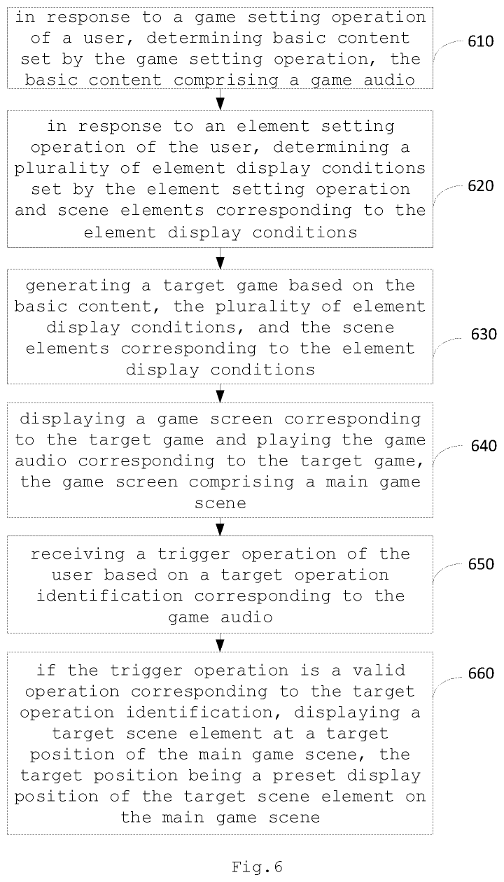

FIG. 6 is a flowchart of a game interaction method provided in an embodiment of the present disclosure, and as shown in FIG. 6, the game interaction method provided in the embodiment includes steps 610-660:

Step 610, in response to a game setting operation of a user, determining basic content set by the game setting operation, the basic content comprising a game audio.

In the embodiment of the present application, the user may perform a game setting operation in the electronic device, to set basic content corresponding to the game. In some embodiments, the basic content may include a game audio, for example, an audio list is displayed in the interactive interface of the electronic device, the audio list includes a plurality of audio name identifications in a local music library of the electronic device or a music library in a remote server, the user may select favorite audio from the audio list as the game audio, and the electronic device may, in response to the game setting operation of the user, determine the game audio set by the game setting operation.

Step 620, in response to an element setting operation of the user, determining a plurality of element display conditions set by the element setting operation and scene elements corresponding to the each element display conditions.

The element display condition in the embodiment of the present disclosure may be understood as a condition to start display an element corresponding to the target operation identification in the interactive interface of the electronic device, and may include starting to display a scene element only when the trigger operation of the user on the target operation identification is a valid operation, and may also include starting to display a scene element only when the trigger operation of the user is a valid operation and a corresponding user total score reaches a certain threshold after the trigger operation of the user is ended, for example, starting to display a scene element such as praise, celebration, encouragement or the like when the trigger operation of the user is a valid operation and the user operation total score reaches a certain threshold.

In the embodiment of the present disclosure, after determining the basic content of the game, the user may perform an element setting operation, to first set a plurality of element display conditions, and then select a scene element corresponding to each element display condition in an element list displayed on the interactive interface, where the scene element may be understood as an element used to enrich the game screen, for example, a building, a plant, an animal, a symbol, and the like, and the electronic device may determine, in response to the element setting operation of the user, the plurality of element display conditions set by the element setting operation and the scene element corresponding to each element display condition.

In some embodiments, the element setting operation may further include setting a display position of the scene element corresponding to each target operation identification in the interactive interface, and the electronic device may determine, in response to the element setting operation of the user, the display position of the scene element corresponding to each target operation identification set by the element setting operation in the interactive interface.

Step 630, generating a target game based on the basic content, the plurality of element display conditions and the scene elements corresponding to each of the element display conditions.

In the embodiment of the present disclosure, after determining the basic content, the plurality of element display conditions and the scene elements corresponding to each of the element display conditions, the electronic device may generate and save a target game based on the basic content, the plurality of element display conditions and the scene elements corresponding to each of the element display conditions.

Step 640, displaying a game screen corresponding to the target game and playing the game audio corresponding to the target game, the game screen comprising a main game scene.

Step 650, receiving a trigger operation of the user based on a target operation identification corresponding to the game audio.

Step 660, if the trigger operation is a valid operation corresponding to the target operation identification, displaying a target scene element at a target position of the main game scene, the target position being a preset display position of the target scene element on the main game scene.

The steps 640-660 in the embodiment of the present disclosure can refer to the contents of the steps 110-130, which are not described herein again.

Therefore, the user can freely create games according to his needs, the creativity of the user is stimulated, the game screens are richer, the screen content of the game screen is more and more perfect, the user can interact with the game scene itself, and the game experience of the user is improved.

In some embodiments of the present disclosure, after the electronic device generates the target game, the electronic device may, in response to a sharing operation of the user, send the target game to other electronic devices corresponding to the sharing operation, so that the other electronic devices run the target game, and thus, the game created by the user may be shared to other users for experience, and the game experience of the user may be further improved.

In other embodiments of the present disclosure, in the process of creating the target game, in response to the game setting operation of the user, the basic content set by the game setting operation is determined, and the basic content may further include a score threshold and preset multimedia content, so that when the user operation total score is greater than or equal to the score threshold corresponding to the target game, the preset multimedia content is displayed.

Therefore, by setting the score threshold and the preset multimedia content, the game operation of the user can be rewarded correspondingly, and the user is encouraged to improve the skill of the beat operation continuously, so that the user can more interact with the game scene itself, and the game experience of the user is improved.

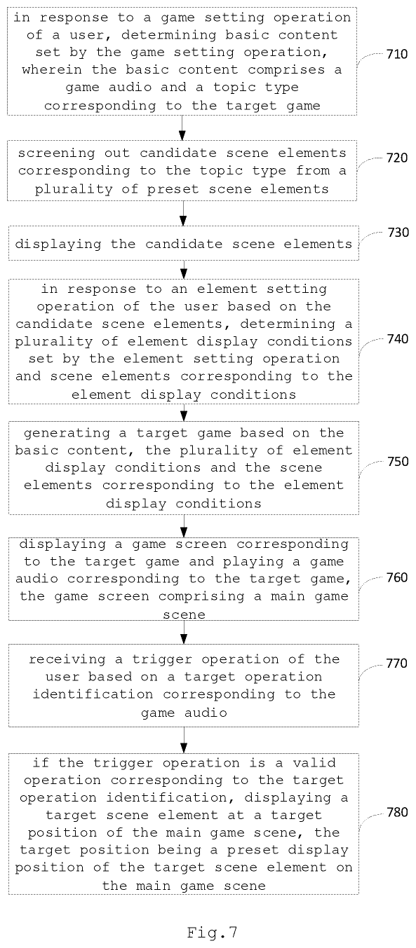

FIG. 7 is a flowchart of a game interaction method provided in an embodiment of the present disclosure, and as shown in FIG. 7, the game interaction method provided in the embodiment includes steps 710-780:

Step 710, in response to a game setting operation of the user, determining basic content set by the game setting operation, wherein the basic content comprises a game audio and a topic type corresponding to the target game.

The topic type in the embodiment of the present disclosure may include topics such as city, country, life, which are not specifically limited herein.

In the embodiment of the present disclosure, the user may create a target game, and during the creation of the target game, the user may perform a game setting operation in the electronic device, and set basic content corresponding to the target game, where the basic content may include a game audio and a topic type corresponding to the target game, for example, the user may select a favorite audio from a local music library of the electronic device or a music library in a remote server as a game audio corresponding to the target game, and select a favorite topic type from a topic type list of the interactive interface as a topic type corresponding to the target game, and the electronic device may determine the game audio set by the game setting operation and the topic type corresponding to the target game in response to the game setting operation of the user.

Step 720, screening out candidate scene elements corresponding to the topic type from a plurality of preset scene elements.

In the embodiment of the present disclosure, the electronic device may store a plurality of preset scene elements corresponding to each topic type in the local storage space or the remote server, and the electronic device may screen out, according to the topic type, a plurality of preset scene elements corresponding to the topic type from the plurality of preset scene elements corresponding to each topic type stored in the local storage space or the remote server, as candidate scene elements. The candidate scene element may be understood as an element for enriching the target game screen, and may be, for example, a building, a plant, an animal, and the like, which is not limited herein.

Step 730, displaying the candidate scene elements.

In the embodiment of the present disclosure, after determining the candidate scene elements corresponding to the topic type, the electronic device may display the candidate scene elements, for example, the candidate scene elements may be displayed in any sidebar in the interactive interface.

Step 740, in response to an element setting operation of the user based on the candidate scene elements, determining a plurality of element display conditions set by the element setting operation and scene elements corresponding to each of the element display conditions.

In the embodiment of the present disclosure, after the candidate scene elements are displayed, the user may perform an element setting operation based on the candidate scene elements, first set a plurality of element display conditions, and then select a target scene element corresponding to the target game from the displayed candidate scene elements, i.e., a scene element corresponding to each element display condition. For related content, reference may be made to the content in the step 620, which is not described in detail here.

Step 750, generating a target game based on the basic content, the plurality of element display conditions and the scene elements corresponding to each of the element display conditions.

The step in the embodiment of the present disclosure may refer to the content of the step 630, and details are not described here.

Step 760, displaying a game screen corresponding to the target game and playing the game audio corresponding to the target game, the game screen comprising a main game scene.

Step 770, receiving a trigger operation of the user based on a target operation identification corresponding to the game audio.

Step 780, if the trigger operation is a valid operation corresponding to the target operation identification, displaying a target scene element at a target position of the main game scene, the target position being a preset display position of the target scene element on the main game scene.

The steps 760-780 in the embodiment of the present disclosure can refer to the contents in the steps 110-130, which are not described herein again.

Therefore, the user can freely create games according to his needs, the creativity of the user is further stimulated, the game screens are richer, and the screen content of the game screen is more and more perfect, so that the user can interact with the game scene itself, and the game experience of the user is improved.

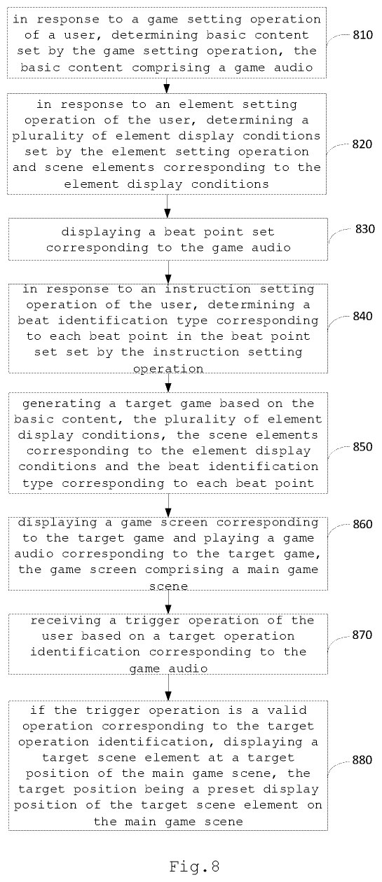

FIG. 8 is a flowchart of a game interaction method provided in an embodiment of the present disclosure, and as shown in FIG. 8, the game interaction method provided in the embodiment includes steps 810-880:

Step 810, in response to a game setting operation of a user, determining basic content set by the game setting operation, the basic content comprising a game audio.

Step 820, in response to an element setting operation of the user, determining a plurality of element display conditions set by the element setting operation and scene elements corresponding to each of the element display conditions.

The steps 810-820 in the embodiment of the present disclosure may refer to the contents of the steps 610-620, which are not described herein again.

Step 830, displaying a beat point set corresponding to the game audio.

In the embodiment of the present disclosure, after determining the game audio set by the game setting operation, the electronic device may generate a beat point set corresponding to the game audio according to the game audio, and display the beat point set corresponding to the game audio in the interactive interface.

Step 840, in response to an instruction setting operation of the user, determining a beat identification type corresponding to each beat point in the beat point set set by the instruction setting operation.

In the embodiment of the present disclosure, the beat identification type corresponding to each beat point in the beat point set may be understood as a type of an operation instruction in the target operation identification corresponding to the beat point, and may include types such as leftward, rightward, upward, downward, long press, and beating a specified animal identification, which are not limited specifically here.

In the embodiment of the present disclosure, the user can perform the instruction setting operation, and set the beat identification type corresponding to the beat point according to actual needs, and then the electronic device can, in response to the instruction setting operation of the user, determine the beat identification type corresponding to each beat point in the beat point set set by the instruction setting operation, and save the beat identification type in the local storage space or the remote server.

In the embodiment of the present disclosure, the electronic device may determine, in response to the instruction setting operation of the user, the beat identification type corresponding to each beat point in the beat point set set by the instruction setting operation.

Step 850, generating a target game based on the basic content, the plurality of element display conditions, the scene element corresponding to each of the element display conditions and the beat identification type corresponding to each beat point.

In the embodiment of the present disclosure, after determining the basic content, the plurality of element display conditions, the scene element corresponding to each of the element display condition, and the beat identification type corresponding to each beat point, the electronic device may generate a target game based on the basic content, the plurality of element display conditions, the scene elements corresponding to the element display conditions, and the beat identification type corresponding to each beat point.

Step 860, displaying a game screen corresponding to the target game and playing the game audio corresponding to the target game, the game screen comprising a main game scene.

Step 870, receiving a trigger operation of the user based on a target operation identification corresponding to the game audio.

Step 880, if the trigger operation is a valid operation corresponding to the target operation identification, displaying a target scene element at a target position of the main game scene, the target position being a preset display position of the target scene element on the main game scene.

The steps 860-880 in the embodiment of the present disclosure can refer to the contents in the steps 110-130, and are not described herein again.

Therefore, the user can freely create games according to his needs, the creativity of the user is stimulated, the game screens are further enriched, and the screen content of the game screen is more and more perfect, so that the user can interact with the game scene itself, and the game experience of the user is improved.

In some embodiments of the present disclosure, after the electronic device displays the beat point set corresponding to the game audio in FIG. 8, the user may further perform a beat point adjustment operation on the beat point set, and adjust the beat points in the beat point set according to his needs, for example, the beat points may be increased or decreased, which is not limited specifically herein, and the electronic device may, in response to the beat point adjustment operation of the user, adjust the beat point set according to a beat point adjustment mode corresponding to the beat point adjustment operation.

Therefore, the user can freely create games according to his needs, the creativity of the user is further stimulated, the game screens are richer, and the screen content of the game screen is more and more perfect, so that the user can interact with the game scene itself, and the game experience of the user is improved.

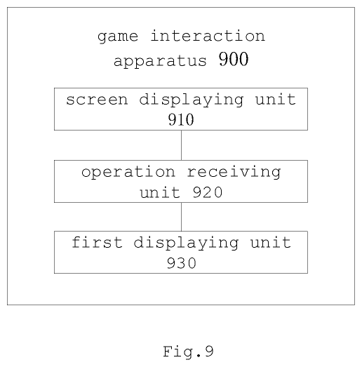

FIG. 9 is a schematic structural diagram of a game interaction apparatus provided by an embodiment of the present disclosure, and as shown in FIG. 9, the game interaction apparatus 900 may include:
a screen displaying unit 910 configured to display a game screen corresponding to a target game, and play a game audio corresponding to the target game, the game screen comprising a main game scene;
an operation receiving unit 920 configured to receive a trigger operation of a user based on a target operation identification corresponding to the game audio;
a first displaying unit 930 configured to, if the trigger operation is a valid operation corresponding to the target operation identification, display a target scene element at a target position of the main game scene, the target position being a preset display position of the target scene element on the main game scene.

Alternatively, the game interaction apparatus 900 may further comprise:
a first determining unit configured to determine an element attribute of the target scene element according to an operation score of the trigger operation;
wherein, the first displaying unit 930 further comprises:
a displaying subunit configured to display the target scene element at the target position according to the element attribute.

Alternatively, the game interaction apparatus 900 may further comprise:
a second displaying unit configured to, in response to starting playing a target audio segment of the game audio, display the target operation identification in the game screen in a first display state, wherein a time moment to start the target audio segment is a time moment to start display of the target operation identification, and the time moment to start display of the target operation identification is determined according to a target beat time moment of a target beat point corresponding to the target operation identification in the game audio;
a control unit configured to control the target operation identification to change from the first display state to a second display state at a constant speed, to cause the target operation identification to be in the second display state at the target beat time moment;
wherein the trigger operation is a touch operation on the target operation identification.

Alternatively, the game interaction apparatus 900 may further comprise:
a third displaying unit configured to display a countdown animation corresponding to the target game;
an aligning unit configured to align an audio timeline corresponding to the game audio and an event timeline corresponding to an identification insertion event set, in a process of the displaying a countdown animation, wherein the identification insertion event set is generated according to a beat point set of the game audio, and the event timeline comprises an initial display time moment of the target operation identification;
wherein, the game interaction apparatus 900 may further comprise:
a second determining unit configured to determine to start playing the target audio segment if the event timeline runs to the initial display time moment of the target operation identification.

Alternatively, the game interaction apparatus 900 may further comprise:
a calling unit configured to call a target beat identification type corresponding to the target beat point;
a first generating unit configured to generate a target operation identification according to the target beat identification type.

Alternatively, the game interaction apparatus 900 may further comprise:
an acquiring unit configured to acquire a user operation total score when the running of the target game ends;
a fourth displaying unit configured to display preset multimedia content if the user operation total score is greater than or equal to a score threshold corresponding to the target game.

Alternatively, the game interaction apparatus 900 may further comprise:
a third determining unit configured to determine, in response to a game setting operation by a user, basic content set by the game setting operation, the basic content comprising a game audio;
a fourth determining unit configured to determine, in response to an element setting operation of the user, a plurality of element display conditions set by the element setting operation and scene element corresponding to each of the element display conditions;
a second generating unit configured to generate the target game based on the basic content, the plurality of element display conditions, and the scene elements corresponding to the element display conditions.

Alternatively, the basic content further comprises a score threshold and preset multimedia content.

Alternatively, the basic content further comprises a topic type corresponding to the target game.

The game interaction apparatus 900 may further comprise:
a screening unit configured to screen out candidate scene elements corresponding to the topic type from a plurality of preset scene elements;
a fifth displaying unit configured to display the candidate scene elements;
wherein the element setting operation is an operation based on the candidate scene elements.

Alternatively, the game interaction apparatus 900 may further comprise:
a sixth displaying unit configured to display a beat point set corresponding to the game audio;
a fifth determining unit configured to determine, in response to an instruction setting operation of the user, a beat identification type corresponding to each beat point in a beat point set set by the instruction setting operation;
wherein the first generating unit comprises:
a generating subunit configured to generate the target game based on the basic content, the plurality of element display conditions, the scene elements corresponding to the element display conditions and the beat identification type corresponding to each beat point.

Alternatively, the game interaction apparatus 900 may further comprise:
an adjusting unit configured to, in response to a beat point adjustment operation of the user, adjust each beat point in the beat point set according to a beat point adjustment mode corresponding to the beat point adjustment operation.

It should be noted that, the game interaction apparatus 900 may perform each step in the game interaction method embodiment, and implement each process and effect in the game interaction method embodiment, which are not described herein again.

The embodiments of the present disclosure also provide an electronic device that may comprise a processor and a memory that may be configured to store executable instructions. The processor may be configured to read the executable instructions from the memory and execute the executable instructions to implement the game interaction method in the foregoing embodiments.

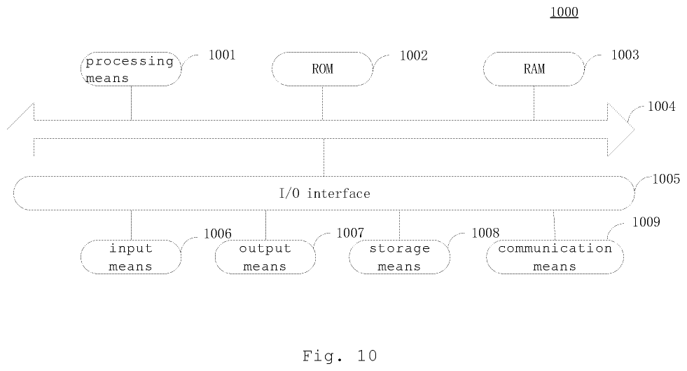

FIG. 10 shows a schematic structural diagram of an electronic device provided by an embodiment of the present disclosure. Referring now specifically to FIG. 10, a schematic structural diagram of an electronic device 1000 suitable for use in implementing the embodiments of the present disclosure is shown.

The electronic device 1000 in the embodiments of the present disclosure may comprise, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (e.g., an in-vehicle navigation terminal), a wearable device, and a fixed terminal such as a digital TV, a desktop computer, a smart home device.

It should be noted that the electronic device 1000 shown in FIG. 10 is only an example, and should not bring any limitation to the functions and the use range of the embodiment of the present disclosure.

As shown in FIG. 10, the electronic device 1000 may comprise a processing means (e.g., a central processing unit, a graphics processing unit, etc.) 1001, which may perform various appropriate actions and processes according to a program stored in a read-only memory (ROM) 1002 or a program loaded from a storage means 1008 into a random access memory (RAM) 1003. In the RAM 1003, various programs and data necessary for the operations on the electronic device 1000 are also stored. The processing means 1001, ROM 1002, and RAM 1003 are connected with each other via a bus 1004. An input/output (I/O) interface 1005 is also connected to the bus 1004.

Generally, the following means may be connected to the I/O interface 1005: an input means 1006 including, for example, a touch screen, touch pad, keyboard, mouse, camera, microphone, accelerometer, gyroscope, etc.; an output means 1007 including, for example, a liquid crystal display (LCD), speaker, vibrator, etc.; the storage means 1008 including, for example, a magnetic tape, hard disk, etc.; and a communication means 1009. The communication means 1009 may allow the electronic device 1000 to communicate with another device wirelessly or by wire to exchange data. While FIG. 10 illustrates the electronic device 1000 having the various means, it should be understood that not all illustrated means are required to be implemented or provided. More or fewer means may be alternatively implemented or provided.

The embodiments of the present disclosure also provide a non-transitory computer-readable storage medium storing a computer program that, when executed by a processor, causes the processor to implement the game interaction method in the foregoing embodiments.

In particular, according to the embodiments of the present disclosure, the processes described above with reference to the flow diagrams may be implemented as a computer software program. For example, the embodiment of the present disclosure comprises a computer program product, the computer program product comprising a computer program carried on a non-transitory computer-readable medium, the computer program containing program code for performing the method illustrated by the flow diagrams. In such an embodiment, the computer program may be downloaded from a network via the communication means 1009 and installed, or installed from the storage means 1008, or installed from the ROM 1002. When executed by the processing means 1001, the computer program performs the above functions defined in the game interaction method of the embodiment of the present disclosure.

It should be noted that the non-transitory computer-readable medium of the present disclosure may be a non-transitory computer-readable signal medium or a non-transitory computer-readable storage medium or any combination of the above two. The non-transitory computer-readable storage medium may be, for example, but not limited to, an electronic, magnetic, optical, electromagnetic, infrared, or semiconductor system, apparatus, or device, or any combination of the foregoing. More specific examples of the non-transitory computer-readable storage medium may comprise, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the non-transitory computer-readable storage medium may be any tangible medium that can contain, or store a program for use by or in conjunction with an instruction execution system, apparatus, or device. In contrast, in the present disclosure, the non-transitory computer-readable signal medium may comprise a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The non-transitory computer-readable signal medium may be any non-transitory computer-readable medium other than the non-transitory computer-readable storage medium, wherein the non-transitory computer-readable signal medium can send, propagate, or transmit a program for use by or in conjunction with an instruction execution system, apparatus, or device. The program code contained on the non-transitory computer-readable medium may be transmitted using any appropriate medium, including but not limited to: a wire, an optical cable, RF (Radio Frequency), etc., or any suitable combination of the foregoing.

In some embodiments, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above non-transitory computer-readable medium may be embodied in the above electronic device; or may be exist separately without being assembled into the electronic device.

The above non-transitory computer-readable medium has one or more programs carried thereon, which, when executed by the electronic device, cause the electronic device to perform the method according to the above disclosure.

In the embodiments of the present disclosure, computer program code for performing the operations of the present disclosure may be written in one or more programming languages or a combination thereof, which include but are not limited to an object-oriented programming language such as Java, Smalltalk, C++, and include a conventional procedural programming language, such as the “C” language or similar programming languages. The program code may be executed entirely on a user's computer, partly on the user's computer, as a stand-alone software package, partly on the user's computer and partly on a remote computer, or entirely on the remote computer or server. In a scenario where the remote computer is involved, the remote computer may be connected to the user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent one module, program segment, or portion of code, which comprises one or more executable instructions for implementing a specified logical function. It should also be noted that, in some alternative implementations, functions noted in blocks may occur in an order different from that noted in the drawings. For example, two blocks shown in succession may, in fact, be executed substantially concurrently, or the blocks may sometimes be executed in a reverse order, which depends upon the functions involved. It will also be noted that each block of the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved unit described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, exemplary types of the hardware logic component that may be used include: a field programmable gate array (FPGA), application specific integrated circuit (ASIC), application specific standard product (ASSP), system on chip (SOC), complex programmable logic device (CPLD), and the like.

In the context of this disclosure, a machine-readable medium may be a tangible medium, which can contain, or store a program for use by or in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

The foregoing description is only the preferred embodiments of the present disclosure and an illustration of the technical principles employed. It should be appreciated by those skilled in the art that the disclosure scope involved in the present disclosure is not limited to the technical solutions formed by specific combinations of the technical features described above, but also encompasses other technical solutions formed by arbitrary combinations of the above technical features or equivalent features thereof without departing from the above disclosed concepts. For example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing might be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented separately or in any suitable sub-combination in multiple embodiments.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is:

1. A game interaction method comprising:
displaying a game screen corresponding to a target game and playing a game audio corresponding to the target game, the game screen comprising a main game scene;
receiving a trigger operation of a user based on a target operation identification corresponding to the game audio; and
if the trigger operation is a valid operation corresponding to the target operation identification, displaying a target scene element at a target position of the main game scene, the target position being a preset display position of the target scene element on the main game scene.

2. The method according to claim 1, wherein if the trigger operation is a valid operation corresponding to the target operation identification, the method further comprises:
determining an element attribute of the target scene element according to an operation score of the trigger operation;
wherein the displaying a target scene element at a target position of the main game scene comprises:
displaying the target scene element on the target position according to the element attribute.

3. The method according to claim 1, wherein in a process of the displaying a game screen corresponding to a target game and playing a game audio corresponding to the target game, the method further comprises:
in response to starting playing a target audio segment of the game audio, displaying the target operation identification in the game screen in a first display state, wherein a time moment to start the target audio segment is a time moment to start display of the target operation identification, and the time moment to start display of the target operation identification is determined according to a target beat time moment of a target beat point corresponding to the target operation identification in the game audio;
controlling the target operation identification to change from the first display state to a second display state at a constant speed, to cause the target operation identification to be in the second display state at the target beat time moment;
wherein the trigger operation is a touch operation on the target operation identification.

4. The method according to claim 3, wherein before the playing a game audio corresponding to the target game, the method further comprises:
displaying a countdown animation corresponding to the target game;
aligning an audio timeline corresponding to the game audio and an event timeline corresponding to an identification insertion event set, in a process of the displaying a countdown animation, wherein the identification insertion event set is generated according to a beat point set of the game audio, and the event timeline comprises an initial display time moment of the target operation identification;
wherein, the method further comprises:
determining to start playing the target audio segment if the event timeline runs to the initial display time moment of the target operation identification.

5. The method according to claim 3, wherein before displaying the target operation identification in the game screen in the first display state, the method further comprises:
calling a target beat identification type corresponding to the target beat point; and
generating the target operation identification according to the target beat identification type.

6. The method according to claim 1, characterized by further comprising:
when the running of the target game ends, acquiring a user operation total score; and
if the user operation total score is greater than or equal to a score threshold corresponding to the target game, displaying preset multimedia content.

7. The method according to claim 1, wherein before the displaying a game screen corresponding to a target game and playing a game audio corresponding to the target game, the method further comprises:
in response to a game setting operation of a user, determining basic content set by the game setting operation, the basic content comprising a game audio;
in response to an element setting operation of the user, determining a plurality of element display conditions set by the element setting operation and scene elements corresponding to the element display conditions; and
generating the target game based on the basic content, the plurality of element display conditions, and the scene elements corresponding to the element display conditions.

8. The method according to claim 7, wherein the basic content further comprises a score threshold and preset multimedia content.

9. The method according to claim 7, wherein the basic content further comprises a topic type corresponding to the target game;
wherein after the determining basic content set by the game setting operation, the method further comprises:
screening out candidate scene elements corresponding to the topic type from a plurality of preset scene elements;
displaying the candidate scene elements;
wherein the element setting operation is an operation based on the candidate scene elements.

10. The method according to claim 7, wherein before the generating the target game based on the basic content, the plurality of element display conditions, and the scene elements corresponding to the element display conditions, the method further comprises:
displaying a beat point set corresponding to the game audio;
in response to an instruction setting operation of the user, determining a beat identification type corresponding to each beat point in the beat point set set by the instruction setting operation;
wherein, the generating the target game based on the basic content, the plurality of element display conditions, and the scene elements corresponding to the element display conditions comprises:
generating the target game based on the basic content, the plurality of element display conditions, the scene elements corresponding to the element display conditions and the beat identification type corresponding to each beat point.

11. The method according to claim 10, wherein after the displaying a beat point set corresponding to the game audio, the method further comprises:
in response to a beat point adjustment operation of the user, adjusting each beat point in the beat point set according to a beat point adjustment mode corresponding to the beat point adjustment operation.

12. A game interaction apparatus, characterized by comprising:
a screen displaying unit configured to display a game screen corresponding to a target game and play a game audio corresponding to the target game, the game screen comprising a main game scene;
an operation receiving unit configured to receive a trigger operation of a user based on a target operation identification corresponding to the game audio; and
a first displaying unit configured to, if the trigger operation is a valid operation corresponding to the target operation identification, display a target scene element at a target position of the main game scene, the target position being a preset display position of the target scene element on the main game scene.

13. An electronic device comprising:
a processor;
a memory configured to store executable instructions;
wherein the processor is configured to read the executable instructions from the memory and execute the executable instructions to implement a game interaction method, wherein the method includes:
displaying a game screen corresponding to a target game and playing a game audio corresponding to the target game, the game screen comprising a main game scene;
receiving a trigger operation of a user based on a target operation identification corresponding to the game audio; and
if the trigger operation is a valid operation corresponding to the target operation identification, displaying a target scene element at a target position of the main game scene, the target position being a preset display position of the target scene element on the main game scene.

14. The electronic device according to claim 13, wherein if the trigger operation is a valid operation corresponding to the target operation identification, the processor is configured to read the executable instructions from the memory and execute the instructions to further implement steps of:
determining an element attribute of the target scene element according to an operation score of the trigger operation;
wherein the displaying a target scene element at a target position of the main game scene comprises:
displaying the target scene element on the target position according to the element attribute.

15. The electronic device according to claim 13, wherein in a process of the displaying a game screen corresponding to a target game and playing a game audio corresponding to the target game, the processor is configured to read the executable instructions from the memory and execute the instructions to further implement steps of:
in response to starting playing a target audio segment of the game audio, displaying the target operation identification in the game screen in a first display state, wherein a time moment to start the target audio segment is a time moment to start display of the target operation identification, and the time moment to start display of the target operation identification is determined according to a target beat time moment of a target beat point corresponding to the target operation identification in the game audio;
controlling the target operation identification to change from the first display state to a second display state at a constant speed, to cause the target operation identification to be in the second display state at the target beat time moment;
wherein the trigger operation is a touch operation on the target operation identification.

16. The electronic device according to claim 15, wherein before the playing a game audio corresponding to the target game the processor is configured to read the executable instructions from the memory and execute the instructions to further implement steps of:
displaying a countdown animation corresponding to the target game;
aligning an audio timeline corresponding to the game audio and an event timeline corresponding to an identification insertion event set, in a process of the displaying a countdown animation, wherein the identification insertion event set is generated according to a beat point set of the game audio, and the event timeline comprises an initial display time moment of the target operation identification; and
determining to start playing the target audio segment if the event timeline runs to the initial display time moment of the target operation identification.

17. The electronic device according to claim 15, wherein before displaying the target operation identification in the game screen in the first display state the processor is configured to read the executable instructions from the memory and execute the instructions to further implement steps of:
calling a target beat identification type corresponding to the target beat point; and
generating the target operation identification according to the target beat identification type.

18. A computer-readable storage medium storing a computer program which, when executed by a processor, causes the processor to implement the game interaction method according to claim 1.

19. A computer-readable storage medium storing a computer program which, when executed by a processor, causes the processor to implement the game interaction method according to claim 2.

20. A computer-readable storage medium storing a computer program which, when executed by a processor, causes the processor to implement the game interaction method according to claim 3.
